(19) United States
(12) Patent Application Publication
(10) Pub. No.: US 2018/0047983 A1
(43) Pub. Date: Feb. 15, 2018

(54) SURFACE-TREATED CATHODE ACTIVE MATERIAL FOR AQUEOUS LITHIUM SECONDARY BATTERY

(71) Applicant: INCHEON UNIVERSITY INDUSTRY ACADEMIC COOPERATION FOUNDATION, Incheon (KR)

(72) Inventors: JUN YOUNG MUN, Incheon (KR); TRON ARTUR, Incheon (KR); JAE MIN KIM, Incheon (KR); NAK GYU GO, Incheon (KR)

(73) Assignee: INCHEON UNIVERSITY INDUSTRY ACADEMIC COOPERATION F OUNDATION, Incheon (KR)

(21) Appl. No.: 15/671,162

(22) Filed: Aug. 8, 2017

(30) Foreign Application Priority Data
Aug. 9, 2016 (KR) 10-2016-0101351

(51) Int. Cl. H01M 4/505; H01M 4/583; H01M 4/64; H01M 10/052

(52) U.S. Cl. CPC H01M 4/505; H01M 10/052; H01M 4/583; H01M 4/64; H01M 2004/028

(57) ABSTRACT

The present invention relates to a surface-treated cathode active material for an aqueous lithium secondary battery, and more particularly, to a surface-treated cathode active material in which deterioration of the surface structure of an active material caused by side reactions between an aqueous electrolyte solution and the active material may be prevented by uniformly coating a predetermined amount of a stabilization material (for example, AlF₃) onto the surface of the cathode active material (for example, LiMn₂O₄) for a lithium secondary battery using an aqueous electrolyte, such that the cycle properties (cycle stability and cycle lifetime), rate capability, and output properties of an aqueous lithium secondary battery are greatly enhanced, to a method for preparing the same, and to a cathode and aqueous secondary battery including the same.

### BACKGROUND

The present invention relates to a surface-treated cathode active material for an aqueous lithium secondary battery, and more particularly, to a surface-treated cathode active material in which deterioration of the surface structure of an active material caused by side reactions between an aqueous electrolyte solution and the active material may be prevented by uniformly coating a predetermined amount of a stabilization material (for example, AlF₃) onto the surface of the cathode active material (for example, LiMn₂O₄) for a lithium secondary battery using an aqueous electrolyte, such that the cycle properties (cycle stability and cycle lifetime), rate capability, and output properties of an aqueous lithium secondary battery are greatly enhanced, to a method for preparing the same, and to a cathode and aqueous secondary battery including the same.

There has arisen a need for developing a power source that can be applied to a wide range of fields, from small-sized devices to large-sized equipment such as electric vehicles (EVs) and energy storage systems (ESSs), and lithium-ion batteries (or lithium secondary batteries; LIBs) are considered one of the most reliable power sources.

However, combustible organic electrolyte solutions including volatile carbonates and the like, when used in LIBs, can cause severe safety-related accidents, and thus act as a stumbling block for application in large-scale battery systems for EVs and ESSs.

In order to overcome such limitations, research has been carried out for developing stable electrolytes of types such as polymer, room temperature ionic liquid, and fluoride/phosphide electrolyte solutions.

Among these candidates, aqueous electrolyte solutions are being particularly emphasized due to having advantages such as being extremely safe, having an abundance of raw materials, being environmentally friendly, being economic, and being easy to handle.

However, adoption of aqueous electrolyte solutions is limited, due to poor cyclability resulting from low electrochemical or chemical stability.

Starting from 1994, when J. Dahn first achieved aqueous rechargeable lithium batteries (ARLBs), ARLBs have been extensively researched and investigated.

Cathode materials, such as LiCoO₂, LiFePO₄, and LiMn₂O₄, used in typical LIBs have been proposed for use in ARLBs, in particular, LiMn₂O₄ spinels, due to being environmentally friendly and convenient to synthesize, and having low manufacturing costs and excellent rate capabilities, is considered one of the most promising cathode materials for ARLBs. Moreover, in the case of LiMn₂O₄ spinels, at 4 V vs. Li/Li⁺ (0.96 V vs. NHE), lithiation and delithiation processes occur, which corresponds to a window range in which the electrochemical stability of an aqueous electrolyte solution having an anodic stability of 1.229 V vs. NHE may be maintained.

However, LiMn₂O₄ cathode materials have the disadvantage of exhibiting poor cycle lifetime due to surface instability in an aqueous solution, which is caused by irreversible phase change and the dissolution (elution) of Mn ions into an electrolyte.

The electrochemical behavior of LiMn₂O₄ materials has been investigated in different electrochemical systems having various types of anodes. The majority of scientists have concentrated on maximizing rate capability by adjusting the bulk morphology of LiMn₂O₄, and have had relatively little interest in improving the surface stability of LiMn₂O₄. Even in the case of LIBs using organic electrolytes, the fact that the electrochemical performance of LiMn₂O₄ can be improved by various types of coatings, such as carbon, oxide, and fluoride coatings, is being overlooked.

Meanwhile, olivine-structured LiFePO₄ is receiving significant interest as a cathode material, due to having low manufacturing costs, being environmentally friendly (low toxicity), and having excellent structural stability (safety and long cycle lifetime).

However, LiFePO₄ has the limitation in which the electrochemical performance of an electrode degrades due to low electrical conductivity, slow diffusion of lithium ions, and poor cyclability.

AlF₃ is a material which has a strong and stable Al—F bond, high ionic conductivity, and stable (electro)chemical stability, and is capable of neutralizing oxygen activity on the surface of a cathode material during cycling.

Thus, there is an active need for developing a novel technique for improving electrochemical performance by adopting AlF₃ as a coating material for a cathode active material for ARLBs.

### PRIOR ART DOCUMENT

### Non-Patent Document

(Non-patent document 1) J. M. Tarascon, M. Armand, Review article, issues and challenges facing rechargeable lithium batteries, Nature 414 (2001) 359-367

### SUMMARY

In order to fulfill typical requirements such as those described above, a technical object of the inventive concept is to provide a novel type of surface-modified cathode active material that can achieve improved cycle properties appropriate for lithium secondary batteries using an aqueous electrolyte, as well as relevant performance requirements, such as with respect to rate capability and output properties and the like.

In order to achieve the technical objects described above, the inventive concept provides a surface-treated cathode active material for a lithium secondary battery using an aqueous electrolyte, wherein the surface of the cathode active material is uniformly coated with a metal oxide or metal fluoride which is a stabilization material.

That is, the inventive concept pertains to aqueous lithium secondary batteries, and is an inventive concept that actively overcomes the cycle stability (cycle lifetime) limitations in typical aqueous systems, and also improves the rate capability and the like of components, by utilizing an economical and environmentally friendly cathode active material (for example, LiMn₂O₄ or LiFePO₄), and coating and modifying the surface thereof with a predetermined amount of a stabilization material (for example, AlF₃).

The inventors, through systematic surface analysis, including scanning electron microscopy, x-ray photoelectron spectroscopy, and electrochemical analysis, actively confirmed that a surface coating of a cathode active material successfully reduces surface deterioration of the active material caused by side reactions between an electrolyte solution and the active material.

In the inventive concept, the stabilization material may be represented by Formula 1 below, and specifically, may be AlF₃ or Al₂O₃, and more specifically, may be AlF₃.

MeₐX_{b} [Formula 1]

(In Formula 1 above, Me is one or more selected from the group consisting of Al, Fe, Ti, Zr, Sc, V, Cr, Mn, Co, Ni, Cu, Zn, Mo, Ru, La, Hf, Nb, Ge, Ag, W, Ce, and Si; X is a halogen element or oxygen; a is an integer from 1 to 5; and b is an integer from 1 to 5).

Moreover, in the inventive concept, the cathode active material may be a lithium-containing manganese oxide having a spinel crystal structure, a lithium oxide having an olivine structure, a lithium-containing cobalt oxide (for example, LiCoO₂), or a lithium-containing nickel oxide (for example, LiNiO₂).

Specifically, the cathode active material may be a lithium-containing manganese oxide (for example, LiMn₂O₄; LMO) having a spinel crystal structure represented by Formula 2 below, or a lithium oxide (for example, LiFePO₄; LFP) having an olivine structure represented by Formula 3 below.

Li[LiₓMn₂₋ₓ]O₄ [Formula 2]

(In Formula 2, 0≦x≦0.5).

LiFe₁₋ₓMₓM′_{y}XO₄ [Formula 3]

(In Formula 3, M is one of the elements belonging to group 7 or groups 9 to 12, or two or more such elements adopted at the same time; M′ is one of the transition metal elements, or two or more of the transition metal elements adopted at the same time; X is one or more selected from the group consisting of P, Si, S, As, and Sb; 0≦x≦1; and 0≦y<0.5).

In the inventive concept, the thickness of the coating may be controlled by varying the amount (for example, 0.001-10 wt %, and more specifically, 0.1-5 wt % with respect to the weight of the cathode active material) of the stabilization material used, and thereby, the balance between polarization and surface stabilization may be optimized.

Specifically, in the case of LiMn₂O₄, the optimum effect was achieved when AlF₃ was coated in an amount of 2 wt % (based on the weight of LiMn₂O₄, which is the coating target), and compared to a pristine LiMn₂O₄ material, superb performance, such as a long cycle lifetime of up to a 90% capacity retention rate after 100 cycles, and highly improved rate capability and the like, was exhibited under aqueous electrolyte (for example, Li₂SO₄ aqueous electrolyte solution with 0.1-10 M concentration) conditions. Meanwhile, in the case of LiFePO₄, coating in an amount of 3 wt % with respect to the weight of the cathode active material is appropriate.

Coating of the stabilization material may be performed by a simple chemical deposition method.

In a specific example, LiMn₂O₄ coated with AlF₃ may be synthesized by immersing LiMn₂O₄ powder in an Al(NO₃)₃·9H₂O aqueous solution and then, after adding a NH₄F aqueous solution and then drying the mixed solution, calcining the obtained powder mixture.

According to another aspect of the inventive concept, i) a cathode material for a lithium secondary battery including a cathode active material surface-treated as above, a conductive material, and a binder; ii) a cathode for a lithium secondary battery including such a cathode material and a current collector; and iii) a lithium secondary battery including such a cathode, an anode, a separator, and an aqueous electrolyte are provided.

In the inventive concept, the type of the conductive material, binder, current collector, and separator is not particularly limited, and those typically used in the field may be selected and used.

The type of an anode active material forming the anode (counter electrode) is also not particularly limited, and for example, activated carbon, VO₂, LiV₃O₈, NASICON, LiV₂O₅, and the like may be used. Desirably, activated carbon should be used.

The aqueous electrolyte used may also be one having a composition typically used in the field, and specifically, a 1 M Li₂SO₄ aqueous electrolyte solution should be used.

### BRIEF DESCRIPTION OF THE FIGURES

In FIG. 1, (a) displays XRD patterns of pristine LMO, AlF₃-1-LMO, AlF₃-2-LMO, and AlF₃-3-LMO; and (b) to (e) are SEM images of pristine LMO, AlF₃-1-LMO, AlF₃-2-LMO, and AlF₃-3-LMO, respectively.

FIG. 2 displays XPS spectra of pristine LMO and AlF₃-2-LMO, (a) showing Al 2p spectra; (b) showing F 1s spectra; and (c) showing Mn 2p spectra.

In FIG. 3, (a) and (b) display cyclic voltammetry results for pristine LMO and AlF₃-2-LMO, respectively (*scan rate=0.1 mV s⁻¹, potential range=0-1.2 V); and (c) and (d) display the initial (first) and 50th charge/discharge voltage profiles, respectively, for pristine LMO, AlF₃-1-LMO, AlF₃-2-LMO, and AlF₃-3-LMO; (e) is a graph showing the cycle performances of pristine and AlF₃-coated LiMn₂O₄ samples at 1 C (148 mAh g⁻¹) (*potential range=0-1.1 V, 1 M Li₂SO₄ aqueous electrolyte); and (f) is a graph showing the rate capabilities of pristine and AlF₃-coated LiMn₂O₄ electrodes (*potential range=0-1.1 V).

FIG. 4 illustrates a process for coating LFP with AlF₃; and displays XRD patterns of pristine and coated LFP.

FIG. 5 displays SEM images showing morphology changes in pristine and coated nano LFP before cycling.

FIG. 6 shows analysis results of TEM EDX mapping of AlF₃-coated LFP.

FIG. 7 shows cyclic voltammetry results for pristine and coated LFP.

FIG. 8 displays graphs showing the electrochemical properties (voltage profiles) of pristine and coated LFP.

FIG. 9 displays graphs showing the electrochemical properties (charge/discharge cycles) of pristine and coated LFP.

FIG. 10 shows EIS measurement results for pristine and coated LFP.

FIG. 11 displays SEM images showing morphology changes in LFP pristine and coated LFP after cycling.

FIGS. 12 and 13 display TEM analysis results for pristine and coated LFP after cycling.

FIG. 14 shows XPS analysis results for pristine and coated LFP after 100 cycles.

FIGS. 15 and 16 display graphs showing the electrochemical properties (rate capabilities) of pristine and coated LFP.

### DETAILED DESCRIPTION

Hereinafter, the inventive concept is described in greater detail through examples and experimental examples. However, the examples are merely for facilitating understanding of the inventive concept, and should not be construed as limiting the scope of the inventive concept in any way.

### Example

LiMn₂O₄ was synthesized by a solid phase reaction using a 1:2 M ratio mixture of Li₂CO₃ (Aldrich) and MnO₂ (Aldrich). The mixture was heated at 400° C. and 750° C. for 10 hours and 48 hours in the air, respectively.

In order to synthesize LiMn₂O₄ coated with AlF₃, prepared LiMn₂O₄ powder was immersed in [Al(NO₃)₃·9H₂O] aqueous solution (Aldrich), and then NH₄F aqueous solution (Aldrich) was slowly added until reaching a desired Al:F mole ratio.

The mixed solution was dried in an oven at 120° C. for 1 hour, and the obtained powder mixture was calcined in an inert argon atmosphere at 400° C. for 2 hours to thereby obtain LiMn₂O₄ coated with AlF₃. Here, the total amount of AlF₃ introduced was adjusted to obtain three different products (1, 2, and 3 wt % of AlF₃), which were named AlF₃-1-LMO, AlF₃-2-LMO, and AlF₃-3-LMO respectively.

### Test Conditions

All of the manufactured samples were characterized by x-ray diffraction (XRD) analysis (10° -80°, 20 range, scan rate 0.03°s⁻¹) using a Rigaku SmartLab diffractometer (Cu Kα radiation, 40 kV, 250 mA).

The surface morphology of the powders was observed using a field emission scanning electron microscope (FE-SEM, JSM 7800F), and additional analysis was performed using energy-dispersive x-ray spectroscopy (EDS) and x-ray photoelectron spectroscopy (XPS, Electronics PHI5000 VersaProde II instrument) (source: x-ray aluminum anode).

In order to measure the electrochemical properties of ARLBs, a three-electrode electrochemical cell was configured, in a 1 M Li₂SO₄ aqueous electrolyte solution (separator: glass filter), with working, counter, and reference electrodes.

The working electrode was manufactured by casting a slurry composed of a LiMn₂O₄ (or LiFePO₄) powder, acetylene black (or carbon black), and poly(tetrafluoroethylene) (PTFE, Aldrich) (80:10:10 wt %).

The slurry was uniformly mixed using a pestle and mortar, and then coated on a 0.25 cm² stainless steel mesh (active material load: about 2 mg cm⁻²).

Other than activated carbon being used as the active material and the electrode (geometric surface area: 1 cm²) mass being about 25 mg, the counter electrode was manufactured in the same way as the working electrode.

An Ag/AgCl (0.197 V vs. SHE) electrode system was purchased from WonATech and used as the reference electrode.

Cyclic voltammetry (CV) was performed in a potential range of 0.0-1.2 V (vs. Ag/AgCl) and a scan rate of 0.1 mV s⁻¹ (ZIVE MP1, WonATech).

Constant current charge/discharge testing was performed, using a WonATech battery system at room temperature, at various current rates (1 C=148 mAh g⁻¹) in a potential range of 0-1.1 V (vs. Ag/AgCl).

Test Results 1: LiMnp₄ Coated with AlF₃

### (1) XRD Analysis Results

XRD patterns of pristine LiMn₂O₄ and the three types of LiMn₂O₄ material coated with AlF₃ are displayed in FIG. 1a.

The XRD pattern for LiMn₂O₄ matched up well with a spinel structure having an Fd3m space group, and all of the peaks were assigned (JCPDF: No. 35-0782).

The crystal structure of LiMn₂O₄ did not change even after AlF₃ coating and heat treatment, indicating that the coating material is present only on the surface of LiMn₂O₄.

AlF₃ was not observed in the XRD patterns of the coated samples because the amount of AlF₃ on the surface of the LiMn₂O₄ material was too minuscule to generate a separate diffraction peak.

### (2) SEM Images

FIGS. 1b to 1e are SEM images of pristine LiMn₂O₄ and coated LiMn₂O₄ (1, 2, and 3 wt % of AlF₃).

In FIGS. 1b to 1e, the particles are bipyramidal types, which corresponds to the characteristics of the spinel structure shown in FIG. 1a.

In contrast to pristine LiMn₂O₄ which has clean and smooth surfaces (FIG. 1b), the coated LiMn₂O₄ material has rough surfaces and formed agglomerates. Such rough surfaces were more noticeable as the amount of coating increased (FIGS. 1c to 1e). The surface morphology of LiMn₂O₄ is considered to have been successfully controlled by the AlF₃ material.

Meanwhile, EDS analysis was performed in order to confirm the presence of Al and F elements on the surface of the coated LiMn₂O₄ material.

EDS analysis results showed that the Mn:O mole ratio was close to 1:2, which was the same as that of the LiMn₂O₄ material.

In addition, EDS results showed that Al and F originating from the coating material was also observed, and the concentrations thereof increased with increased amounts of coating.

### (3) XPS Spectra

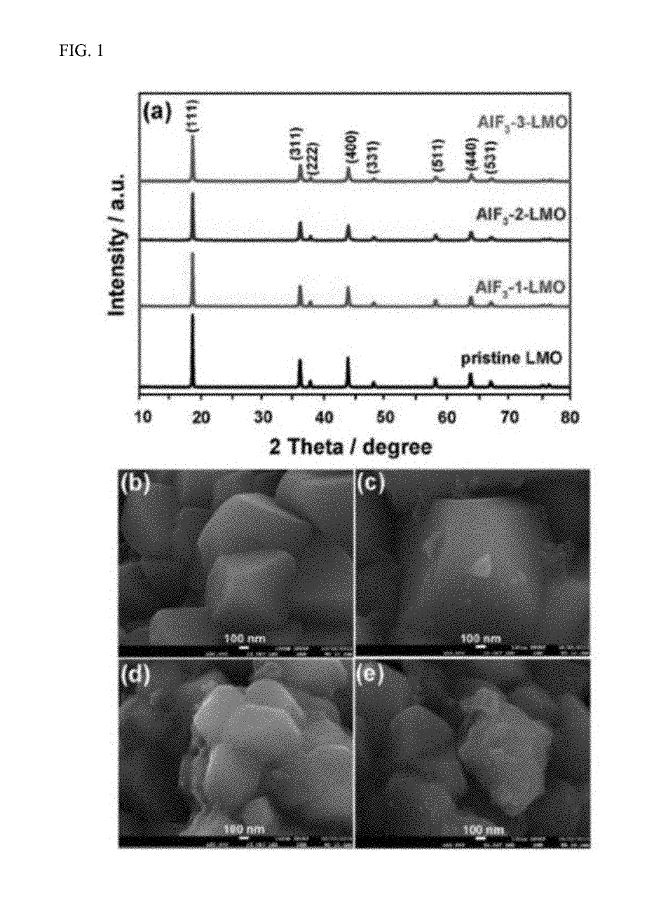

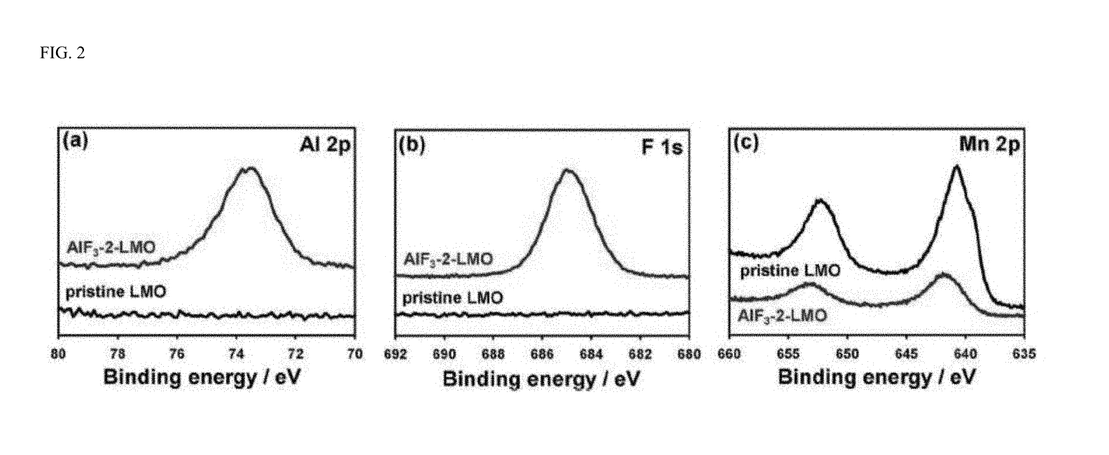

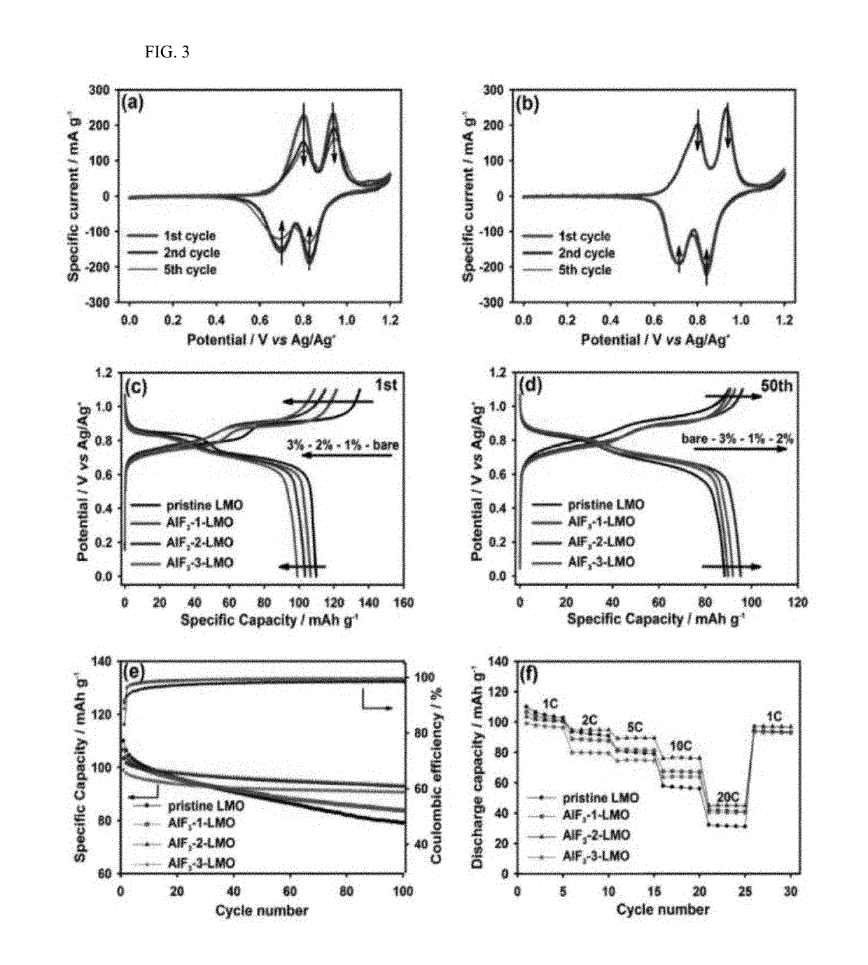

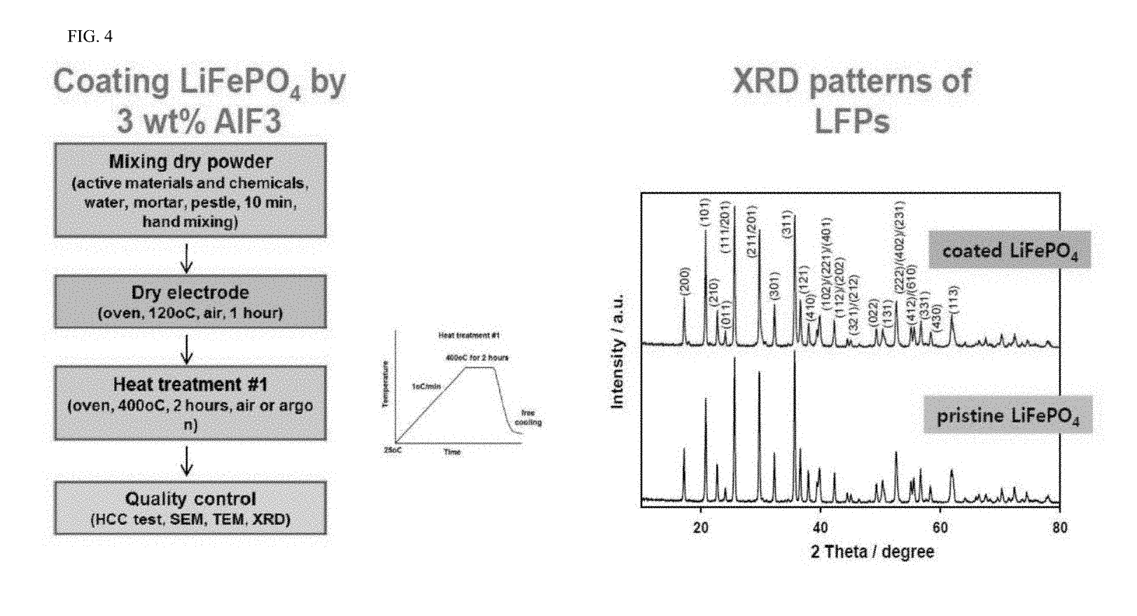

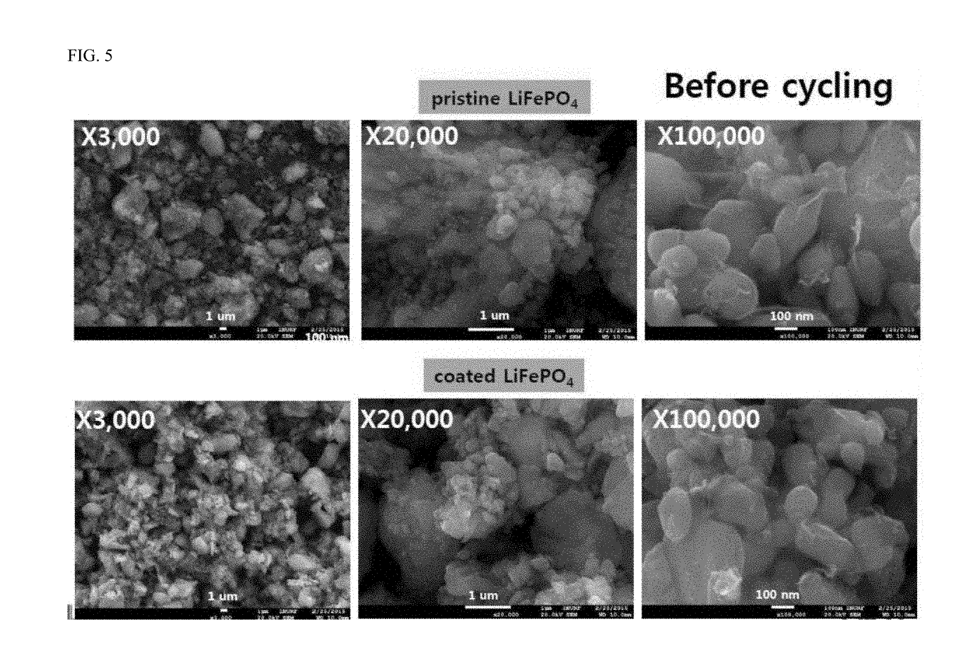

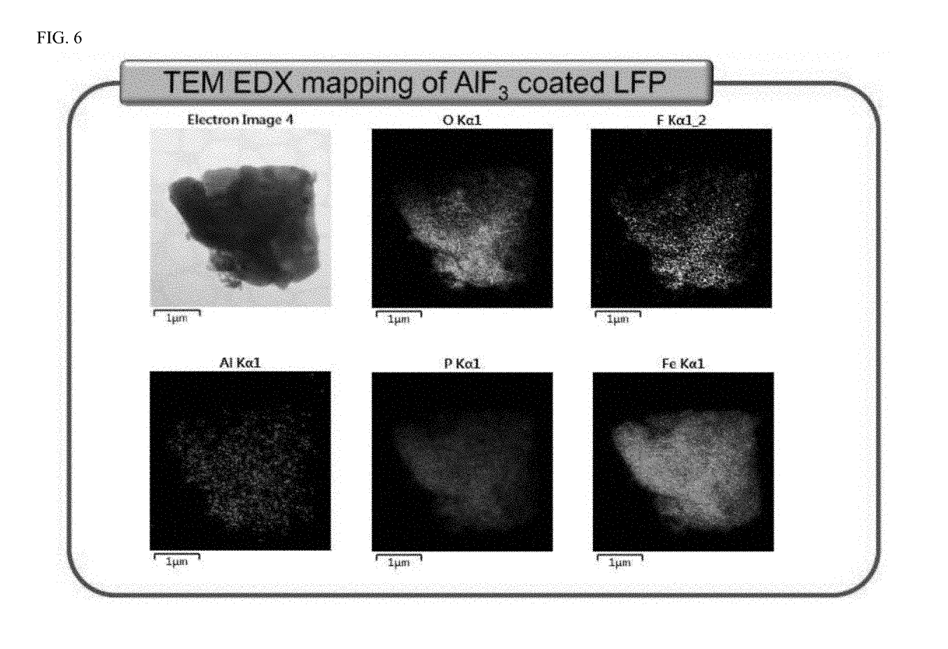

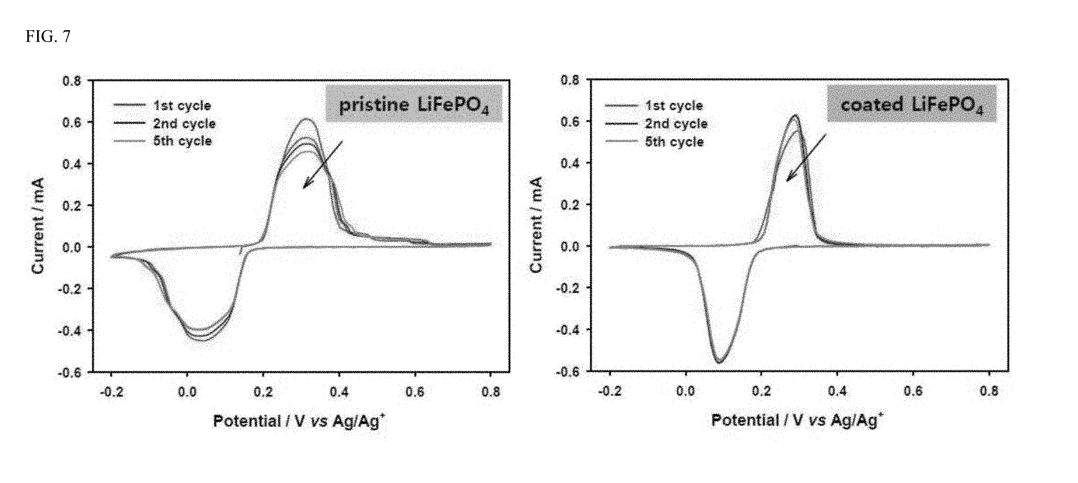

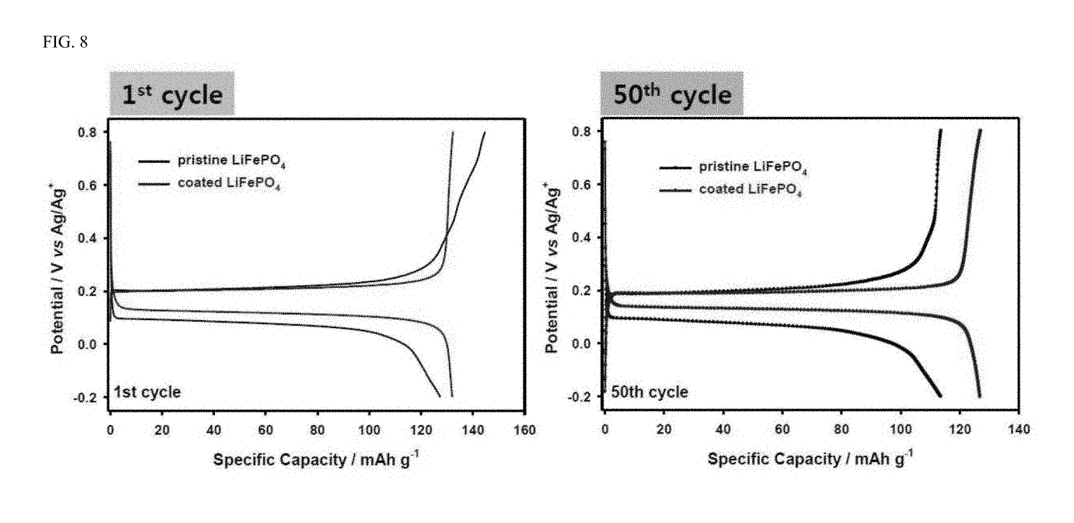

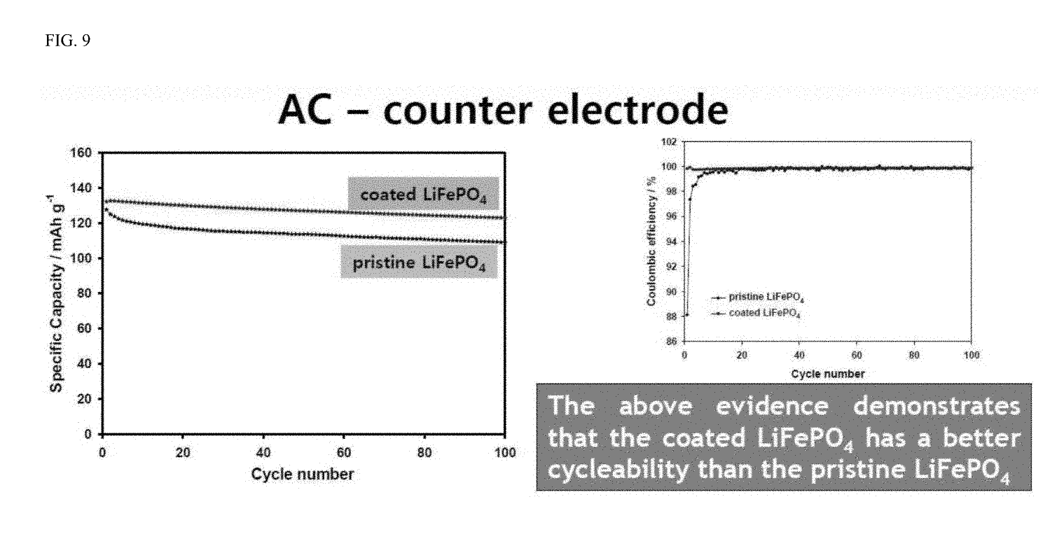

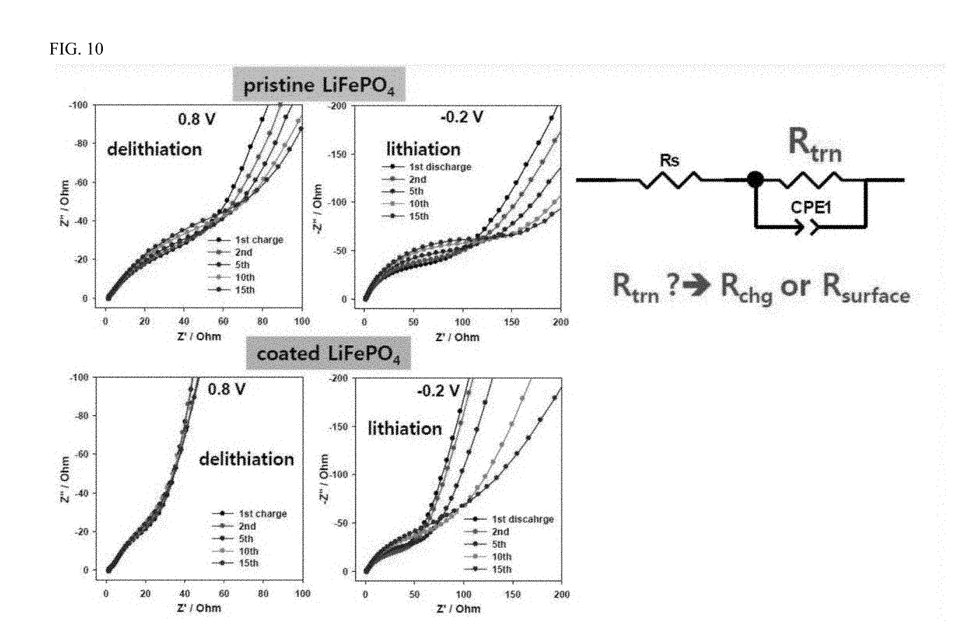

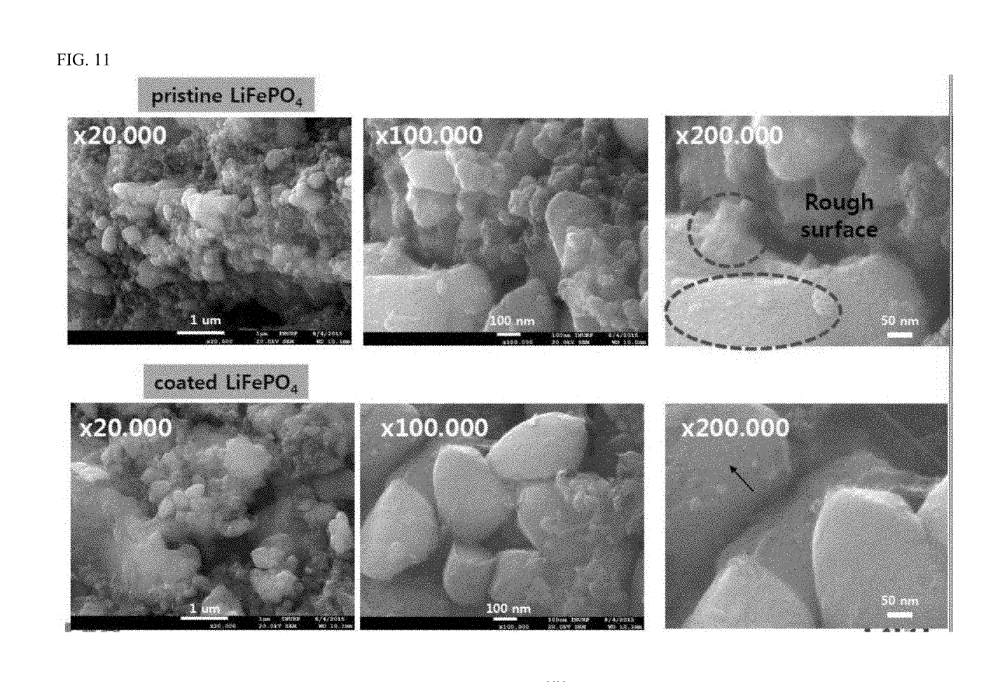

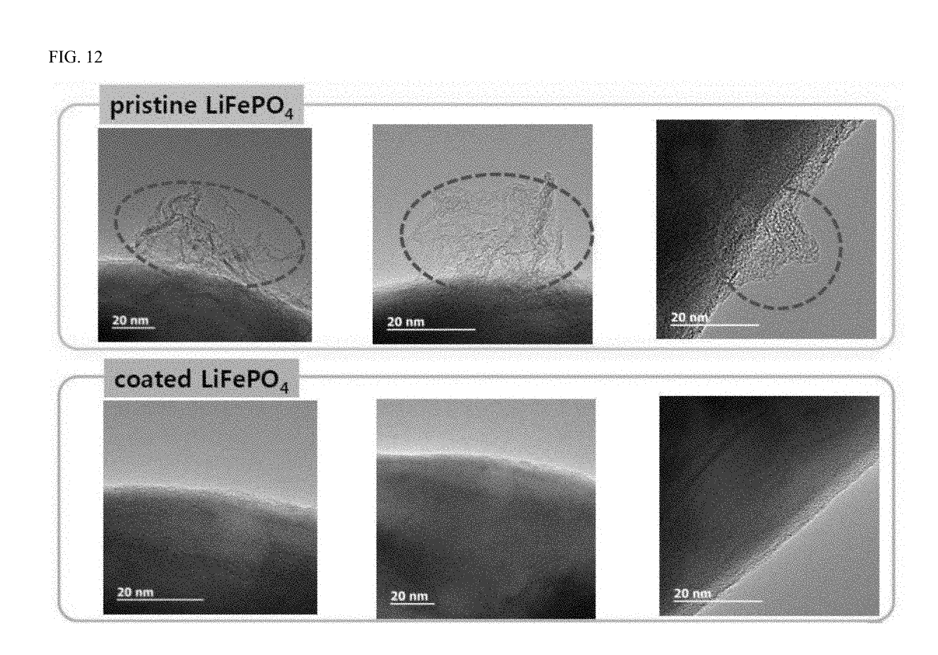

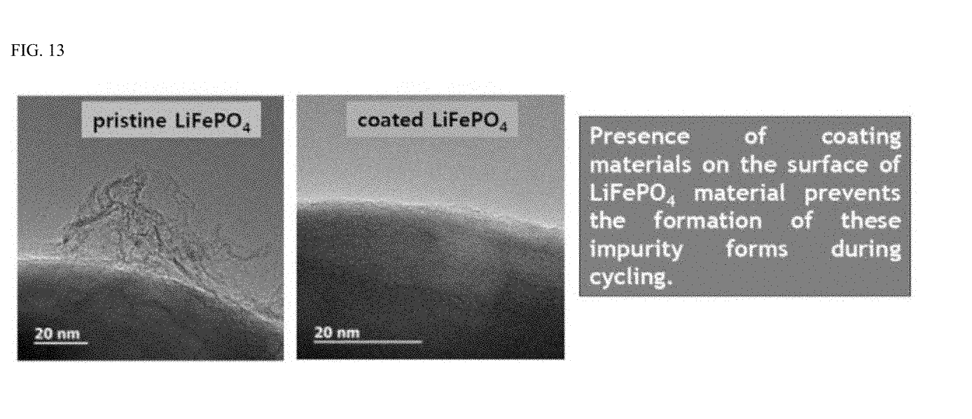

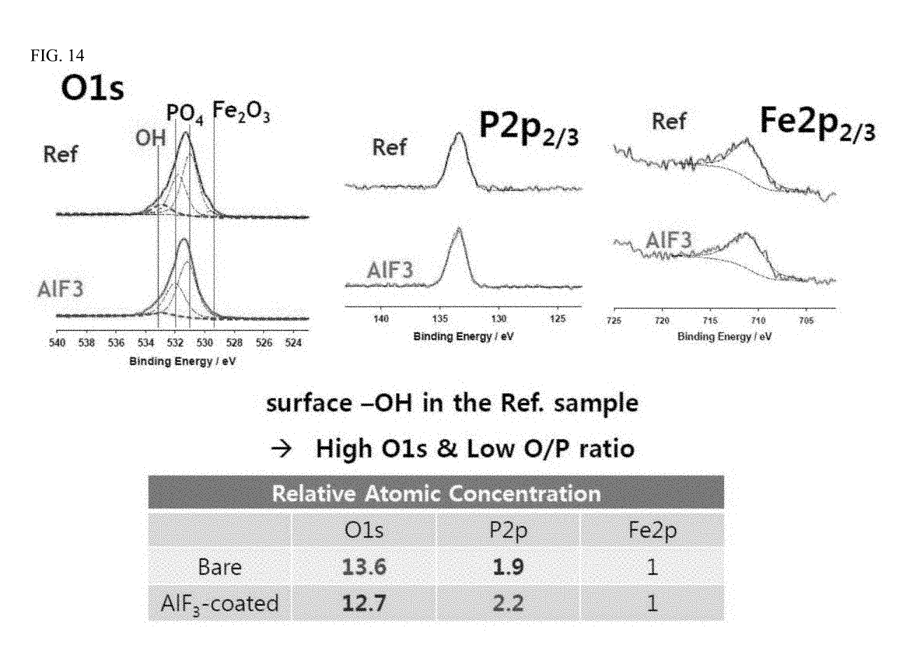

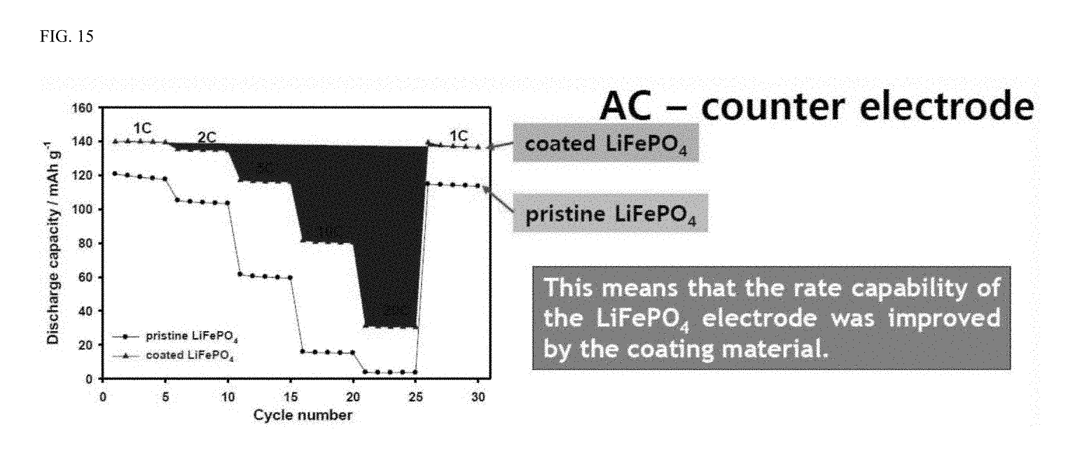

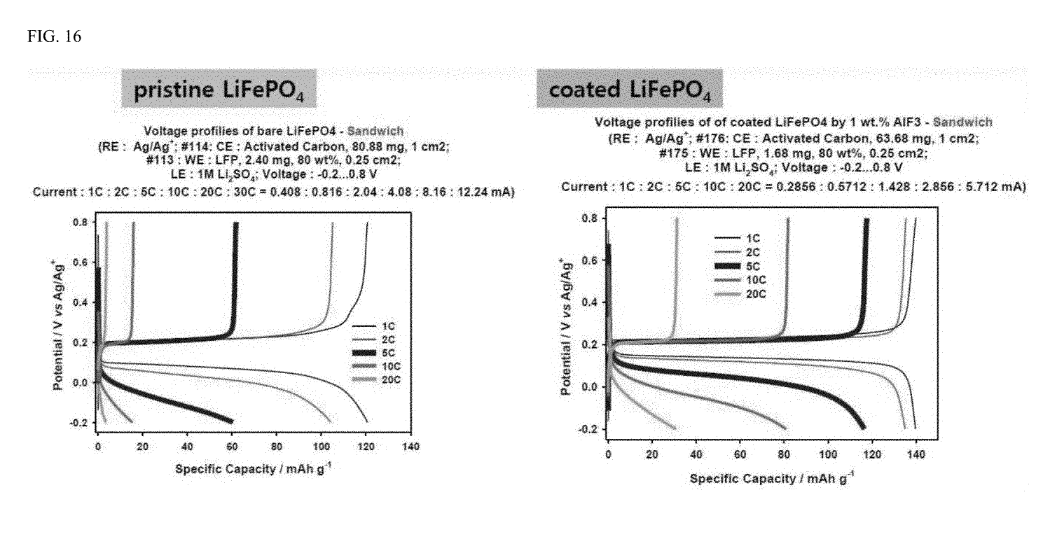

Al 2p, F ls, and Mn 2p XPS spectra for pristine LiMn₂O₄ and AlF₃-2-LMO material are shown in FIGS. 2a to 2c, respectively.

The Al 2p peak (FIG. 2a) at 73.6 eV and the F 1s peak (FIG. 2b) at 684.9 eV respectively correspond to Al³⁺ and F⁻ derived from AlF₃, and were only observed for the surface of AlF₃-2-LMO.

Meanwhile, the peak at 642 eV relating to photoelectrons of Mn ions derived from LiMn₂O₄ decreased with coating film formation (FIG. 2c).

Considering that the amount of Al observed by XPS (only upper surface analyzed) was greater than the overall wt % of Al, this XPS result provides good indication that the surface of the active material is uniformly covered by the AlF₃ coating.

Specifically, the calculated atomic concentration ratio, Al/Mn, for the 1, 2, and 3 wt % AlF₃ coatings on LiMn₂O₄ were 289%, 542%, and 592%, respectively. Such high atomic concentrations of Al on the surface are also strong evidence for the existence of the AlF₃ coating.

### (4) Cyclic Voltammetry, Voltage Profile, and Charge/Discharge Cycling

In order to investigate the effect that the AlF₃ coating on the surface of the LiMn₂O₄ material has on the electrochemical performance of a LiMn₂O₄ electrode in a 1 M Li₂SO₄ aqueous electrolyte solution, cyclic voltammetry was performed first, and the results thereof are displayed in FIGS. 3a and 3b.

Pristine LiMn₂O₄ and LiMn₂O₄ coated with 2 wt % of AlF₃ show two pairs of redox peaks positioned, respectively, at 0.80/0.93 and 0.71/0.83 V (vs. Ag/AgCl), which is the same as the results for typical LIBs using organic electrolytes, reflecting that the AlF₃ coating material does not change the electrochemical behavior of Li⁺ ions. Specifically, both the pristine and coated LiMn₂O₄ material show two couples of charge/discharge stable states (plateaus), indicating that the coating material does not change the intercalation/deintercalation of Li⁺ ions into the LiMn₂O₄ material structure that occurs in the aqueous electrolyte solution during cycling.

As cycling was performed, all current peaks for the pristine sample continued to decrease, indicating that LiMn₂O₄ did not have sufficient stability in the aqueous electrolyte solution. The structure of the pristine LiMn₂O₄ rapidly deteriorated during repeated lithium ion intercalation/deintercalation.

In typical LIBs, the electrochemical decomposition of carbonates can form a solid thin film because solid byproducts such as polycarbonate and lithium carbonate remain. Meanwhile, in the case of aqueous electrolyte solutions, the formation of such types of solids by electrolyte decomposition does not occur. Therefore, a resistive solid-type precipitate derived from the electrolyte is not considered to have caused poor cyclability.

Considering that Jahn-Teller distortion can cause a portion of Mn ions from LiMn₂O₄ to be eluted into the electrolyte solution, it is reasonable to assume that changes to the crystal structure on the surface of LiMn₂O₄ are more severe in aqueous electrolyte solutions than in organic electrolyte solutions.

In FIG. 3b, the peaks of the AlF₃-2-LMO sample are nearly identical to the initial pattern, even after five cycles. That is, the AlF₃ coating has mitigated surface failure, and as a result, excellent cycle lifetime and low dynamic resistance have been achieved (FIG. 3b).

FIGS. 3c and 3d display voltage profiles for pristine and AlF₃-coated LiMn₂O₄ on the first and 50th cycles, respectively (current rate: 1 C (148 mA g⁻¹), potential range: 0-1.1 V (vs. Ag/AgCl)).

In the first cycle voltage profile (FIG. 3c), the pristine LiMn₂O₄ exhibited the highest capacity and lowest polarization among all of the samples, and the initial discharge capacity decreased as the amount of AlF₃ coating increased.

On at least the first cycle, the AlF₃ coating is considered to have formed an additional layer through which lithium ions had to pass, thereby acting as additional resistance to lithium transport.

However, on the 50th cycle, the pristine LiMn₂O₄ exhibited the highest polarization and the lowest capacity among all of the samples (FIG. 3d).

Meanwhile, initial coulombic efficiency increased from 80.5% to 91.6% with increased amounts of AlF₃ coating, indicating that the AlF₃ coating layer is effective for suppressing disadvantageous side reactions between the active material and the aqueous electrolyte.

The effects of the AlF₃ coating can be more clearly observed through FIG. 3e.

Although initial capacity was highest for the pristine LiMn₂O₄ (109.7 mAh g⁻¹), as the cycles continued, capacity reduction began quickly, and on the 100th cycle (capacity retention rate: 71.4%), a specific capacity of only 78.4 mAh g⁻¹ was exhibited.

The LiMn₂O₄ coated with 1, 2, and 3 wt % of AlF₃ exhibits a relatively low first discharge capacity of 106.6, 103.4, and 99.0 mAh g⁻¹, respectively, due to the initial resistance of the AlF₃ coating. Later, however, later, the discharge capacities thereof, at 83.8, 92.9, and 90.7 mAh g⁻¹, respectively, became much higher than that of the pristine LiMn₂O₄.

Moreover, the LiMn₂O₄ material coated with AlF₃ exhibited much higher discharge capacities and coulombic efficiencies than previously reported results.

Therefore, the inventors were confident that coating the surface of a LiMn₂O₄ material with AlF₃ was an extremely viable approach to improving the electrochemical performance of electrode materials for ARLBs.

At the same time, the capacity retention rate improved to 78.6%, 89.8%, and 91.6% as the amount of coating increased from 1 wt % to 3 wt %, and through this, it can clearly be confirmed that the greater the amount of AlF₃ coating, the more effectively the surface could be stabilized as the cycles progressed. The AlF₃ surface coating is considered to have suppressed surface failure of LiMn₂O₄ resulting from irreversible structural changes due to side reactions between the active material and the aqueous electrolyte.

Meanwhile, the specific capacity of LiMn₂O₄ after the 8th cycle was higher than that of AlF₃-1-LMO, and AlF₃-3-LMO continued to exhibit a low specific capacity of less than 100 mAh g⁻¹.

A thin coating of AlF₃ is not very effective at suppressing side reactions on the surface, and conversely, a thick coating is considered to have a disadvantageous effect with regard to polarity due to the surface layer acting as a resistance against lithium transport.

Therefore, it is necessary to optimize the amount of AlF₃ coating, and on the basis of cyclability results, the inventors set the optimal amount of AlF₃ coating material on the surface of the LiMn₂O₄ material to 2 wt %.

In addition, the AlF₃ coating layer also improved the rate capabilities, as seen in FIG. 3f.

The LiMn₂O₄ coated with 2 wt % of AlF₃ exhibited discharge capacities of 103.4, 94.8, 89.1, 76.1, and 44.9 mAh g⁻¹ at 1 C, 2 C, 5 C, 10 C, and 20 C, respectively, which were much higher those of the pristine LiMn₂O₄ material (109.9, 93.6, 80.7, 57.8, and 32.1 mAh g⁻¹). Although pristine LiMn₂O₄, which is unaffected by surface-AlF₃ resistance, had a higher initial discharge capacity, the weakness to surface failure was revealed after only a single cycle.

TABLE 1
Rate Capability Results

| | C-rate/Discharge capacity, mAh g⁻¹ | | | | |
|---|---|---|---|---|---|
| | 1 C | 2 C | 5 C | 10 C | 20 C |
| Pristine LiMn₂O₄ | 109.9 | 93.6 | 80.7 | 57.8 | 32.1 |
| Coated LiMn₂O₄ | 103.4 | 94.8 | 89.1 | 76.1 | 44.9 |

Test Results 2: LiFePO₄ Coated with AlF₃

### (1) XRD Analysis Results

FIG. 4 is a drawing illustrating a process for coating pure LiFePO₄ (LFP) with AlF₃, and displaying XRD patterns of LFP.

That is, FIG. 4 shows that the surface of a cathode active material may be modified by a simple method, and that the structure of the LFP is not changed, even by such a chemical treatment and thermal post-treatment.

### (2) SEM Images

FIG. 5 displays SEM images showing morphology changes in pristine and coated nano LFP before cycling, and FIG. 11 displays SEM images showing morphology changes in pristine and coated LFP after cycling.

That is, the surface morphology of LFP is considered to have been successfully controlled by the AlF₃ material.

### (3) TEM (EDX Mapping) Analysis Results

FIG. 6 shows analysis results of TEM EDX mapping of LFP coated with AlF₃.

That is, it can be confirmed that the surface of LFP was uniformly covered by an AlF₃ coating.

FIGS. 12 and 13 display TEM analysis results for pristine and coated LFP after cycling.

That is, it can be confirmed that impurity forms (for example, Fe(OH)₂ and Fe2O3) were not formed on the surface of LEP particles after cycling (100 cycles). The formation of such impurities during cycling was suppressed due to the presence of the coating material on the surface of the LFP.

Conversely, in the case of a pristine LFP electrode, it was anticipated that impurity forms would be present on the surface of the LFP and degrade the cycle properties.

### (4) Cyclic Voltammetry, Voltage Profile, and Charge/Discharge Cycling

FIG. 7 shows cyclic voltammetry results for pristine and coated LFP.

One pair of redox peaks was clearly observed in each of the curves, indicating that only a single well-define step is present in an electrochemical redox process in the LFP electrode.

Moreover, the current peak of the coated LFP was sharper, and in contrast to the gap of 0.18 V between redox peaks in the coated LFP, the gap was shown to be 0.25 V for the pristine LFP.

Furthermore, the voltage difference between the flat charge and discharge stabilization states was smaller in the case of the coated LFP than in the case of the pristine LFP, indicating that the dynamic properties were improved.

In addition, the pristine and coated LFP materials showed two couples of charge/discharge stabilization states, indicating that the coating material does not change the intercalation/deintercalation of Li⁺ ions into the LFP material during cycling in an aqueous electrolyte solution.

FIG. 8 displays graphs showing the electrochemical properties (voltage profiles) of pristine and coated LFP.

That is, the first coulombic efficiency and cycle properties of the coated LFP were superior to those of the pristine LFP.

FIG. 9 displays graphs showing the electrochemical properties (charge/discharge cycles) of pristine and coated LFP.

Although the initial discharge capacity of the pristine LFP was 127.5 mAh g⁻¹, the discharge capacity rapidly decreased to 108.9 mAh g⁻¹ after 100 cycles, and the capacity retention rate after 100 cycles was also only 85.4%.

Conversely, the initial discharge capacity of the coated LFP was 132.1 mAh g⁻¹, and the capacity was well maintained even after 100 cycles (122.7 mAh g⁻¹), such that an excellent capacity retention rate of 92.9% was exhibited after 100 cycles.

Such points clearly prove that the coated LFP has cycle properties which are far superior to those of the pristine LFP.

FIGS. 15 and 16 display graphs showing the electrochemical properties (rate capabilities) of pristine and coated LFP.

Pristine LFP and coated LFP both exhibited similar discharge capacities at 1 C.

Due to increased resistance at high charge/discharge rates, the discharge capacities of the pristine and coated samples decreased as the C rate increased.

However, the coated LFP material maintained a relatively higher discharge capacity than the pristine LFP at high C rates. That is, the rate capability of the LFP electrode was improved by the coating material.

The low mobility related to Li⁺ diffusion, that is, surface passivation, has a critical role in degrading rate capability.

### (5) EIS Measurement Results

FIG. 10 shows EIS measurement results for pristine and coated LFP.

Since an SEI layer is not formed in an aqueous electrolyte, the internal resistance will be lower in an aqueous system than in an organic electrolyte, and as a result, the aqueous electrolyte exhibits much higher ionic conductivity than the organic electrolyte.

Meanwhile, in the same aqueous solution conditions, the pristine LFP electrode exhibited higher resistance than the coated electrode.

### (6) XPS Analysis Results

FIG. 14 shows XPS analysis results for pristine and coated LFP after 100 cycles.

That is, it can be indirectly confirmed that the surface of the active material was uniformly covered by the AlF₃ coating.

### (7) Summary of Electrochemical Properties

A comparison of the electrochemical properties of the AlF₃-coated LFP with previously reported results and those of the pristine LFP are displayed in Table 2 below.

TABLE 2
Electrochemical properties of LiFePO₄ cathode active materials in various
aqueous electrolytes

| | | | | Capacity in | Capacity | |
|---|---|---|---|---|---|---|
| Cathode | Anode | Electrolyte | Capacity in the 1^{st} | the n^{th} cycle | retention (%) | Current |
| materials | materials | solution | cycle (mAh g⁻¹) | (mAh g⁻¹) | (cycles) | density |
| LiFePO₄ | Activated | Li₂SO₄ | 124 | 82 (10) | 63% (10) | 5 C |
| | carbon | (0.5M) | | | | |
| LiFePO₄/C | VO₁ | LiNO₃ | 106 | 91.4 (80) | 94% (50) | C/3 |
| | | (saturated) | | | | |
| LiFePO₄/C | LiV₃O₈ | LiNO₃ (9M) | 90 | — | 99% (100) | 10 C |
| LiFePO₄ | LiTi₂(PO₄)₃ | Li₂SO₄ (1M) | 55 (1 C) | — | 90% (1000) | 6.0 C |
| LiFePO₄ | Activated | Li₂SO₄ | 58 | — | 45% | 20 C |
| | carbon | (0.5M) | | | | |
| LiFePO₄ | Activated | Li₂SO₄ (1M) | 127.5 | 119.2 (10) | 85% (100) | 1 C |
| | carbon | | | 108.9 (100) | | |
| LiFePO₄/AlF₃ | Activated | Li₂SO₄ (1M) | 132.1 | 191.2 (10) | 93% (100) | 1 C |
| | carbon | | | 122.7 (100) | | |

### Review of Results

In the inventive concept, the surfaces of cathode active material particles were modified by performing an AlF₃ coating through a simple chemical coating method.

Such an AlF₃ coating does not have an effect on the crystal structure of the cathode active material, and lithiation and delithiation processes.

That is, in the inventive concept, a novel physiochemical/electrochemical method capable of greatly improving the electrochemical performance of a cathode active material for an aqueous lithium secondary battery was obtained along with the optimum coating amount most advantageous for such a performance improvement.

This inventive concept is expected to perform an extremely important role in the surface modification of electrode materials for enhancing the electrochemical performance of electrode materials in aqueous electrolyte solutions.

In the inventive concept, a novel type of cathode active material stabilized by surface treatment may be adopted to enhance the electrochemical performance, such as the lifetime properties (cycle properties), rate capability, and output properties and the like, of an aqueous lithium secondary battery.

Meanwhile, such a surface treatment of the inventive concept does not have an effect on the crystal structure of an active material or a lithiation/delithiation process.

Moreover, a cathode active material (LMO and LEP) used in the inventive concept is environmentally friendly, and is economical due to having a low manufacturing cost.

Furthermore, a surface coating of the inventive concept may be easily performed through a simple chemical method.

Thereby, the inventive concept will be capable of contributing significantly to the improvement of the electrochemical performance of an electrode material in an aqueous electrolyte.

What is claimed is:

1. A surface-treated cathode active material for a lithium secondary battery using an aqueous electrolyte, wherein the surface of the cathode active material is uniformly coated with a metal oxide or metal fluoride which is a stabilization material.

2. The cathode active material of claim 1, wherein the stabilization material is represented by Formula 1 below
MeₐX_{b} [Formula 1]
(where Me is one or more selected from the group consisting of Al, Fe, Ti, Zr, Sc, V, Cr, Mn, Co, Ni, Cu, Zn, Mo, Ru, La, Hf, Nb, Ge, Ag, W, Ce, and Si; X is a halogen element or oxygen; a is an integer from 1 to 5; and b is an integer from 1 to 5).

3. The cathode active material of claim 2, wherein the stabilization material is AlF₃ or Al₂O₃.

4. The cathode active material of claim 3, wherein the stabilization material is AlF₃.

5. The cathode active material of claim 4, wherein the cathode active material is a lithium-containing manganese oxide having a spinel crystal structure, a lithium oxide having an olivine structure, a lithium-containing cobalt oxide, or a lithium-containing nickel oxide.

6. The cathode active material of claim 5, wherein the cathode active material is the lithium-containing manganese oxide having a spinel crystal structure represented by Formula 2 below
Li[LiₓMn₂₋ₓ]O₄ [Formula 2]
(where 0≦x≦0.5),
or the lithium oxide having an olivine structure represented by Formula 3 below
LiFe₁₋ₓMₓM′_{y}XO₄ [Formula 3]
(where M is one of the elements belonging to group 7 or groups 9 to 12, or two or more such elements adopted at the same time; M′ is one of the transition metal elements, or two or more of the transition metal elements adopted at the same time; X is one or more selected from the group consisting of P, Si, S, As, and Sb; 0≦x<1; and 0≦y<0.5).

7. The cathode active material of claim 6, wherein the cathode active material is LiMn₂O₄ or LiFePO₄.

8. The cathode active material of claim 7, wherein the AlF₃ is coated in an amount of 0.001-10 wt % with respect to the weight of the cathode active material.

9. The cathode active material of claim 8, wherein the AlF₃ is coated in an amount of 2 wt % with respect to LiMn₂O₄ or 3 wt % with respect to LiFePO₄.

10. A method for preparing a cathode active material for a lithium secondary battery, wherein LiMn₂O₄ coated with AlF₃ is synthesized by immersing LiMn₂O₄ powder in an Al(NO₃)₃·9H₂O aqueous solution and then, after adding a NH₄F aqueous solution and then drying the mixed solution, calcining the obtained powder mixture.

11. A lithium secondary battery comprising:
a cathode for a lithium secondary battery comprising the surface-treated cathode active material according to claims 1, a conductive material, a binder and a current collector;
an anode;
a separator; and
an aqueous electrolyte.

12. The lithium secondary battery of claim 11, wherein the anode uses activated carbon as an anode active material.

13. The lithium secondary battery of claim 11, wherein the aqueous electrolyte is a 0.1-10 M Li₂SO₄ aqueous electrolyte solution.

14. The lithium secondary battery of claim 13, wherein the aqueous electrolyte is a 1 M Li₂SO₄ aqueous electrolyte solution.
